(19) United States
(12) Patent Application Publication
(10) Pub. No.: US 2026/0108096 A1
(43) Pub. Date: Apr. 23, 2026

(54) PORTAFILTER ASSEMBLY FOR A BEVERAGE MAKER

(71) Applicant: Hamilton Beach Brands, Inc., Glen Allen, VA (US)

(72) Inventor: Richard Arena, Glen Allen, VA (US)

(73) Assignee: Hamilton Beach Brands, Inc., Glen Allen, VA (US)

(21) Appl. No.: 19/352,004

(22) Filed: Oct. 7, 2025

Related U.S. Application Data
(60) Provisional application No. 63/710,216, filed on Oct. 22, 2024.
(60) Provisional application No. 63/743,361, filed on Jan. 9, 2025.

(51) Int. Cl. A47J 31/06; A47J 31/60

(52) U.S. Cl. CPC A47J 31/0663; A47J 31/60

(57) ABSTRACT

A portafilter for a beverage-making machine includes: a main basket with a cavity; a filter holder positioned at least partially in the main basket; and a lifting ring that engages the filter holder and the main basket. One of the lifting ring and the main basket has a first recess that defines a first partial helix and the other of the lifting ring has a first nub received in the first recess, and one of the lifting ring and the filter holder has a second recess that defines a second partial helix and the other of the lifting ring and the filter holder has a second nub received in the second recess. The first partial helix and the second partial helix are of opposite rotative directions. Rotation of the cover causes the lifting ring and the cover to change elevation relative to the main basket and further causes the filter holder to change elevation relative to the main basket.

### RELATED APPLICATIONS

The present application claims priority from and the benefit of U.S. Provisional Patent Application Nos. 63/710,216, filed Oct. 22, 2024, and 63/743,361, filed Jan. 9, 2025, each of which is hereby incorporated herein by reference in full.

### FIELD OF THE INVENTION

The present invention relates generally to small appliances, and more specifically to beverage makers.

### BACKGROUND

An espresso machine typically brews coffee by forcing pressurized, near-boiling water through a “puck” of ground coffee. The puck is formed in a portafilter where the grounds were packed and then portafilter is locked to the machine. A thick, concentrated coffee called “espresso” is thereby extracted. Extracting is also known as pulling. A grouphead is the mechanical receiver on an espresso machine for the removable portafilter. A typical consumer espresso machine has one grouphead. Professional machines, such as those used at commercial coffee shops, usually have two or more groupheads. During the process of extracting, or pulling, a shot of espresso, hot water is forced through the grouphead and portafilter under high pressure.

The portafilter attaches to the grouphead of an espresso machine and holds the tamped puck of coffee grounds within a basket. The portafilter is usually made of brass or stainless steel, with a plastic or wooden handle. The portafilter forms a seal with a grouphead gasket of the espresso machine and directs high-pressure hot water through the coffee puck to extract espresso.

After a shot of espresso has been pulled, the user must then remove the puck of grounds from the brew chamber of the portfilter. Some commercial espresso machines employ a knockbox, a device used in some instances to release and store spent espresso grounds (or pucks) after a shot of espresso has been pulled. A knockbox is generally a small open top box made from stainless steel. The box has a sturdy rubber covered bar (also known as a bash bar) against which a portafilter is “knocked” to forcibly release the puck. Knockboxes are typically very sturdy as they are subject to repetitive knocking and tapping to dislodge espresso pucks after use. Consumer espresso machines typically involve some manual manipulation by the user to remove the puck from the brew chamber of the portafilter. Sometimes visual re-inspection and additional wiping of remaining grounds from the portafilter with a towel are also required given that the grounds are tamped into the portafilter and water is forced through the grounds at high pressure. The portafilter may be used again for making another shot of espresso only after it has been properly cleaned.

Though wide varieties of espresso machine designs have been proposed or produced, alternative ways to remove a puck from a portafilter may be desired.

### SUMMARY

As a first aspect, embodiments of this present disclosure are directed a portafilter for a beverage-making machine. The portafilter comprises: a main basket with a cavity; a filter holder positioned at least partially in the main basket; and a lifting ring that engages the filter holder and the main basket. One of the lifting ring and the main basket has a first recess that defines a first partial helix and the other of the lifting ring has a first nub received in the first recess, and one of the lifting ring and the filter holder has a second recess that defines a second partial helix and the other of the lifting ring and the filter holder has a second nub received in the second recess. The first partial helix and the second partial helix are of opposite rotative directions. Rotation of the cover causes the lifting ring and the cover to change elevation relative to the main basket and further causes the filter holder to change elevation relative to the main basket.

As a second aspect, embodiments of the present disclosure are directed to a portafilter for a beverage-making machine comprising: a main basket with a cavity; a filter holder positioned at least partially in the main basket; a lifting ring that engages the filter holder and the main basket; and a cover detachably fixed to the lifting ring. One of the lifting ring and the main basket has a first recess that defines a first partial helix and the other of the lifting ring has a first nub received in the first recess, and one of the lifting ring and the filter holder has a second recess that defines a second partial helix and the other of the lifting ring and the filter holder has a second nub received in the second recess. The first partial helix and the second partial helix are of opposite rotative directions. When viewed from an overhead vantage point, counterclockwise rotation of the cover causes the lifting ring and the cover to change elevation relative to the main basket and further causes the filter holder to change elevation relative to the main basket.

As a third aspect, embodiments of the present disclosure are directed to a portafilter for a beverage-making machine. The portafilter includes: a main basket with a cavity; a filter holder positioned at least partially in the main basket; a lifting ring that engages the filter holder and the main basket; and a cover detachably fixed to the lifting ring. One of the lifting ring and the main basket has a first recess that defines a first partial helix and the other of the lifting ring has a first nub received in the first recess, and one of the lifting ring and the filter holder has a second recess that defines a second partial helix and the other of the lifting ring and the filter holder has a second nub received in the second recess. The first partial helix and the second partial helix are of opposite rotative directions. Rotation of the cover and the lifting ring causes the lifting ring to rise relative to the main basket, and wherein rotation of the cover and the lifting ring causes the filter holder to rise relative to the lifting.

### BRIEF DESCRIPTION OF THE FIGURES

FIG. 1 is a front perspective view of a beverage-making machine according to embodiments of the disclosure.

FIG. 2 is a side section view of the portafilter of the beverage-making machine of FIG. 1, shown in its lowered position and with a puck of grounds in the main basket.

FIG. 3 is a front perspective section view of the portafilter as in FIG. 2.

FIG. 4 is a perspective view of the lifting ring of the portafilter of FIG. 2.

FIGS. 5-7 are sequential side section views of the portafilter of FIG. 2 and the tamping unit of the beverage-making machine of FIG. 1, showing how the tamping unit compresses loose grounds into a puck for brewing.

FIG. 8 is a front perspective section view of the portafilter in the lowered position after brewing, such that the puck of grounds needs to be ejected.

FIG. 9 is a side quarter-section view of the portafilter of FIG. 8 shown in an intermediate position.

FIG. 10 is a front perspective section view of the portafilter of FIG. 8 shown in a raised position that allows the puck of grounds to be removed.

FIG. 11 is a front quarter-section perspective view of the portafilter of FIG. 8 shown in a raised position.

FIG. 12A is a top perspective view of a portafilter that may be used with the beverage-making machine of FIG. 1 according to embodiments of the present disclosure.

FIG. 12B is a bottom perspective view of the portafilter of FIG. 12A.

FIG. 12C is an exploded side perspective view of the portafilter of FIG. 12A.

FIG. 12D is a partial bottom perspective view of the portafilter of FIG. 12A illustrating the engagement of the main basket, the filter holder, the lifting ring, and the elastomeric boot according to embodiments of the present disclosure.

FIG. 13A is a top perspective view of the main basket of the portafilter of FIG. 12A according to embodiments of the present disclosure.

FIG. 13B is a bottom perspective view of the main basket of FIG. 13A.

FIG. 14A is a top perspective view of the filter plate of the portafilter of FIG. 12A according to embodiments of the present disclosure.

FIG. 14B is a side view of the filter plate of FIG. 14A.

FIG. 15A is a top perspective view of the filter holder (and puck of grounds) of the portafilter of FIG. 12A according to embodiments of the present disclosure.

FIG. 15B is a bottom perspective view of the filter holder of FIG. 15A.

FIG. 15C is another bottom perspective view of the filter holder of FIG. 15A.

FIG. 16A is a top perspective view of the lifting ring of the portafilter of FIG. 12A according to embodiments of the present disclosure.

FIG. 16B is a bottom perspective view of the lifting ring of FIG. 16A.

FIG. 16C is a top view of the lifting ring of FIG. 16A.

FIG. 17A is a top perspective view of the elastomeric boot of the portafilter of FIG. 12A according to embodiments of the present disclosure.

FIG. 17B is a bottom perspective view of the elastomeric boot of FIG. 17A.

FIG. 18A is a top perspective view of the cover of the portafilter of FIG. 12A according to embodiments of the present disclosure.

FIG. 18B is a bottom perspective view of the cover of FIG. 18A.

FIG. 19A is a top perspective view of the diverting outlet of the portafilter of FIG. 12A according to embodiments of the present disclosure.

FIG. 19B is a bottom perspective view of the diverting outlet of FIG. 19A.

FIG. 20 is a bottom perspective view of an alternative cover and diverting outlet for the portafilter of FIG. 12A according to embodiments of the present disclosure.

FIG. 21 is a perspective view of a portafilter according to additional embodiments of the disclosure.

FIG. 22 is a front section view of the portafilter of FIG. 21.

FIG. 23 is a perspective view of the main basket of the portafilter of FIG. 21.

FIG. 24 is a top view of the main basket of FIG. 23.

FIG. 25 is a top perspective view of the lifting ring of the portafilter of FIG. 21.

FIG. 26 is a top perspective view of the filter holder of the portafilter of FIG. 21.

FIG. 27 is a front perspective section view of the filter holder of FIG. 26.

### DETAILED DESCRIPTION

The present disclosure of various embodiments of an invention will now be described more fully with reference to the accompanying drawings. This disclosure may, however, include additional embodiments of various forms and should not be construed as limited to the embodiments set forth herein; rather, these embodiments are provided so that this disclosure will be thorough and complete and will fully convey the scope of an invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or”includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

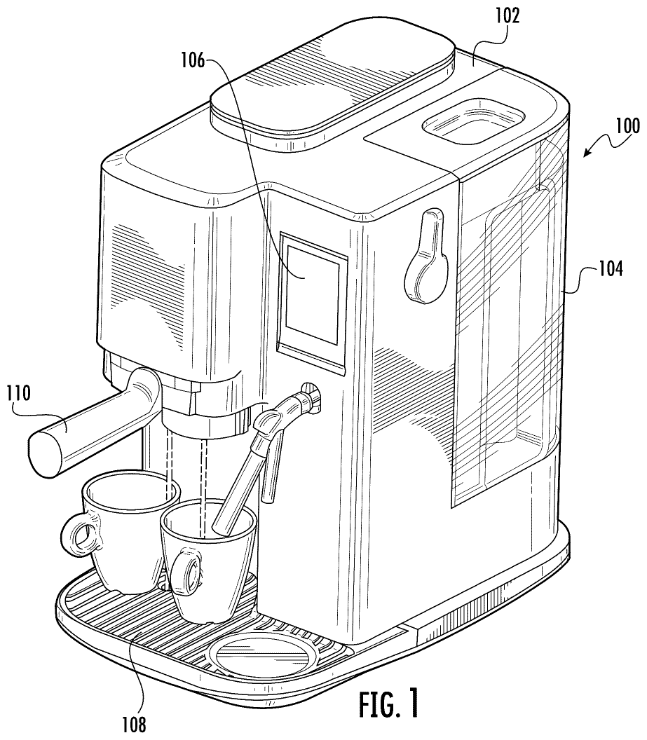

Referring now to FIG. 1, a schematic diagram of a beverage maker (e.g., an espresso machine), designated broadly at 100, is shown therein. As shown in FIG. 1, the espresso machine 100 includes a housing 102 on which are mounted a water reservoir 104, a grinding unit 106 for grinding beans, and a stage 108 for receiving one or two cups into which espresso is to be brewed. A portafilter 110 is mounted to the housing 102 above the stage 108. The water reservoir 104, grinding unit 106 and stage 108 may be of conventional design and need to be described in detail herein. The portafilter 110 is described in greater detail below.

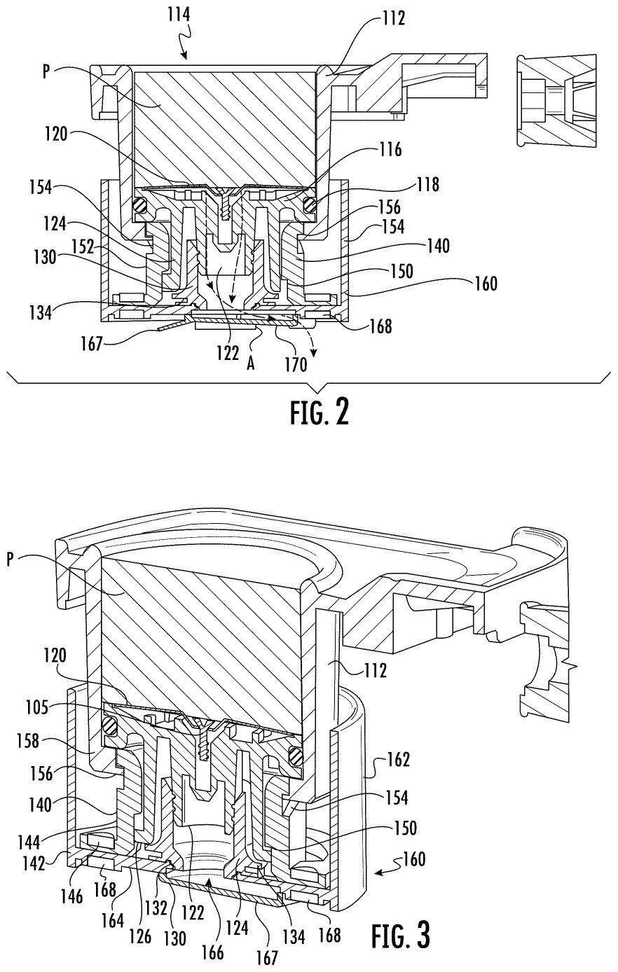

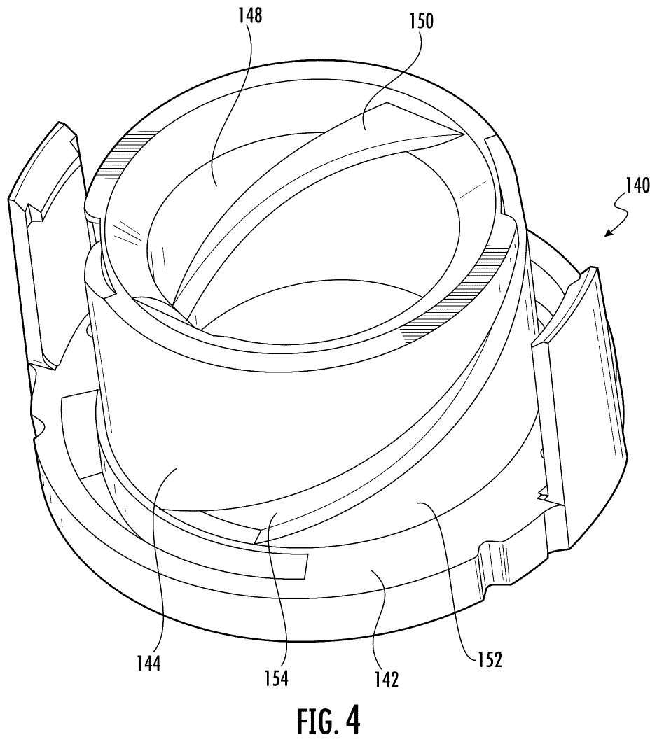

Referring now to FIGS. 2 and 3, the portafilter 110 includes a main basket 112 with a cavity 114. A filter holder 116 is positioned within the cavity 114 of the main basket 112. One or more fingers 156 may extend outwardly from a lower lip 158 of the main basket 112. As described in further detail below, according to embodiments of the present disclosure, the filter holder 116 is configured to move vertically relative to the main basket 112, for example, to help remove or eject a “puck” of ground coffee from the main basket 112. A seal ring 118 encircles the filter holder 116 and engages the inner wall of the main basket 112, thereby providing a seal. A porous filter plate 120 is mounted to the upper surface of the filter holder 116. In some embodiments, the filter holder 116 comprises an inner ring 122 and an outer ring 124. The inner ring 122 of the filter holder 116 is positioned below the filter plate 120. The outer ring 124 surrounds the inner ring 122. In some embodiments, one or more feet 126 extend outwardly from a lower end of the outer ring 124 of the filter holder 116.

Referring again to FIGS. 2 and 3, the portafilter 110 further includes a generally cylindrical elastomeric boot 130 positioned below the filter holder 116. The inner ring 124 of the filter holder 116 is configured to fit within and engage an inner surface of the boot 130 (enhanced by circumferential ridges 132), while the outer ring 124 is positioned radially outwardly from the boot 130. In some embodiments, one or more lips 134 extend radially outwardly from a lower end of the boot 130.

Referring still to FIGS. 2 and 3 and also to FIG. 4, the portafilter 110 further includes a lifting ring 140. The lifting ring 140 is generally cylindrical and is positioned radially outwardly of the outer ring 124 of the filter holder 116. In some embodiments, an outer lip 142 extends radially outwardly from a lower end of a main wall 144 of the lifting ring 140. Magnets 146 may be embedded in the outer lip 142 of the lifting ring 140. An inner surface 148 of the main wall 144 may include two partially-helical inner recesses 150. In some embodiments, the feet 126 of the outer ring 124 of the filter holder 116 are received in a respective inner recess 150 of the lifting ring 140. In addition, in some embodiments, an outer surface 152 of the main wall 144 may include two partially-helical outer recesses 154. The fingers 156 extending from the lower lip 158 of the main basket 112 are received in a respective outer recess 154 of the lifting ring 140.

Notably, the inner recesses 150 and the outer recesses 154 are rotationally opposed to each other; i.e., in some embodiments, the inner recesses 150 define a “left-handed” or “counterclockwise” thread, whereas the outer recesses 154 define a “right-handed” or “clockwise” thread. In other embodiments, the inner recesses 150 may define a “right-handed” or “clockwise” thread and the outer recesses 154 may define a “left-handed” or “counterclockwise” thread.

Referring further to FIGS. 2 and 3, the portafilter 110 further includes a cover 160. The cover 160 is generally cylindrical and includes a wall 162 and a floor 164. The wall 162 of the cover 160 is positioned radially outwardly of the main basket 112 and the floor 164 of the cover 160 underlies the outer lip 142 of the lifting ring 140. An opening 166 in the floor 164 leads to a diverting outlet 167 that is fixed to the underside of the floor 164 of the cover 160. Magnets 168 may be embedded in the floor 164 at positions that align with corresponding magnets 146 of the lifting ring 140, thereby enabling the cover 160 and the lifting ring 140 to rotate and vertically move together. Also, in some embodiments, a circular ridge 170 extends upwardly just outwardly from the opening 166 which is configured to engage the lower end of the boot 130.

During operation of the espresso machine 100 (FIG. 1), the portafilter 110 begins in a lowered position, as shown in FIGS. 2, 3 and 8. In the lowered position, the fingers 156 of the main basket 112 are positioned at the upper ends of the outer recesses 154 in the outer surface 152 of the lifting ring 140, and the feet 126 of the filter holder 116 are positioned in the lower ends of the inner recesses 150 in the inner surface 148 of the lifting ring 140. This position provides sufficient room within the main basket 112 above the filter plate 120 for grounds.

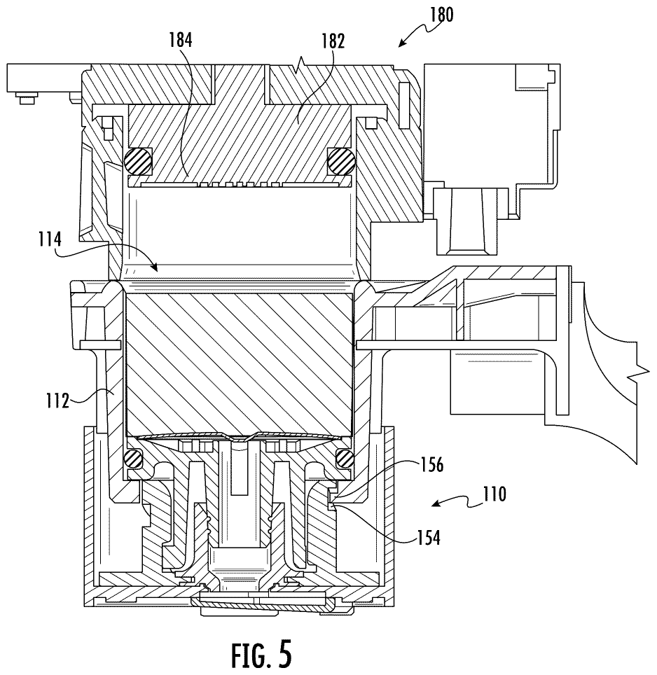

With the portafilter 110 in the lowered position, beans are ground in the grinding unit 104 and are conveyed (typically through gravity) to the cavity 114 of the main basket 112. A tamping unit 180 (which is typically mounted within the housing 102) is then employed to tamp the loose grounds into a solid “puck” for brewing. As shown in FIGS. 5-7, the tamping unit 180 includes a plunger 182 or similar device to compress the loose grounds against the filter plate 120 withing the main basket 112. In the illustrated embodiment, the plunger 182 includes a “showerhead” 184 that delivers water from the water reservoir 104 to the puck as it resides in the main basket 112. The structure and operation of the tamping unit 180 can be conventional and need not be described in detail herein.

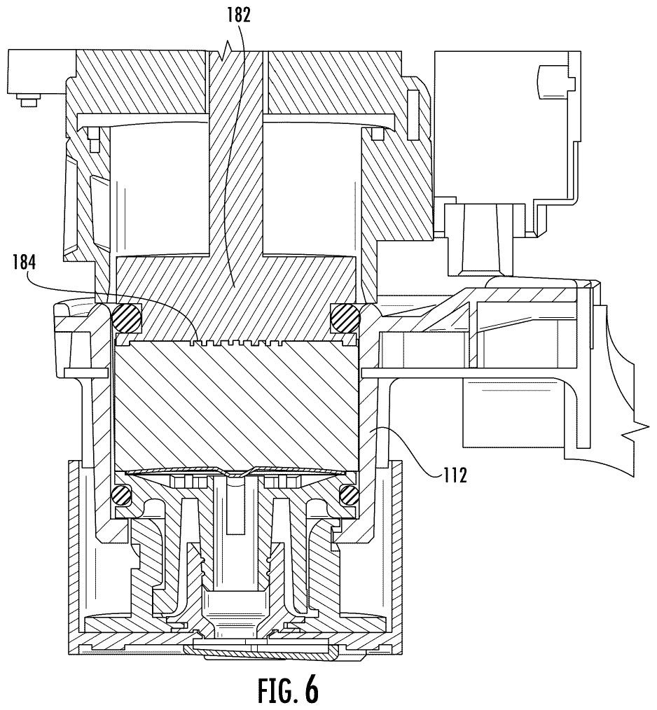

Once the grounds have been tamped into a puck (FIG. 6), espresso can then be brewed in a largely conventional manner. As shown by the arrows A in FIG. 2, water or steam introduced into the main basket 112 through the showerhead 184 drips through the puck of grounds to produce a brewed beverage. The brewed liquid descends through the filter plate 120 and into the interior of the inner ring 122 of the filter holder 116. The brewed liquid then flows into the interior of the boot 130, through an opening 166 in the floor 164 of the cover 160, and into the diverting outlet 167, where the flow is split into two streams that are then dispensed into one or two receptacles (e.g., cups) positioned on the stage 108 (FIG. 1).

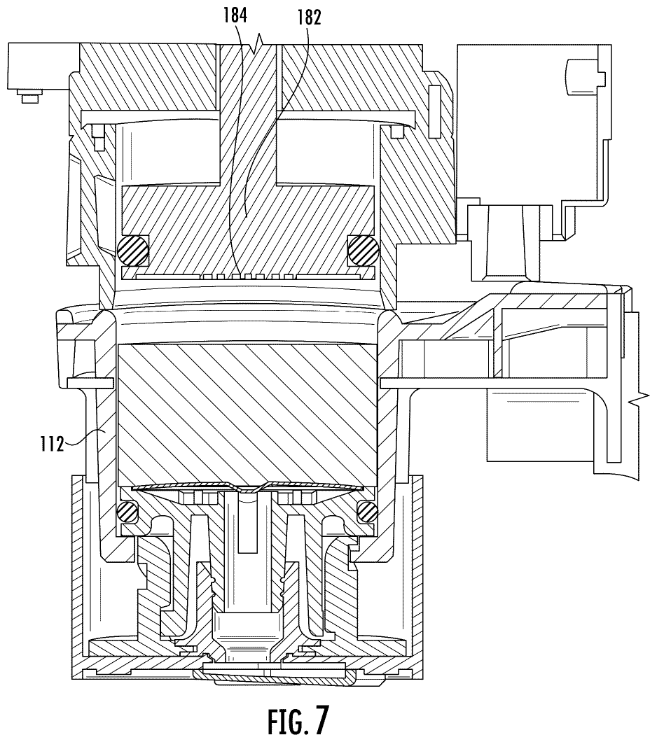

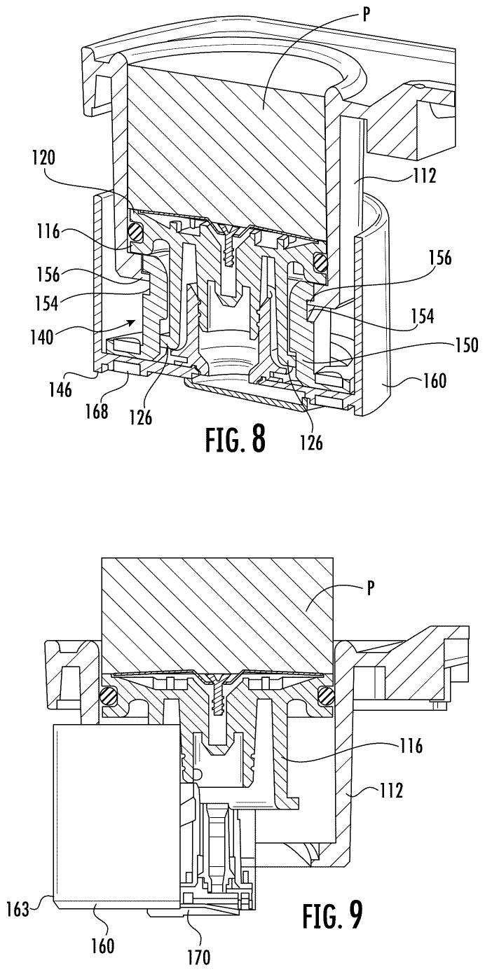

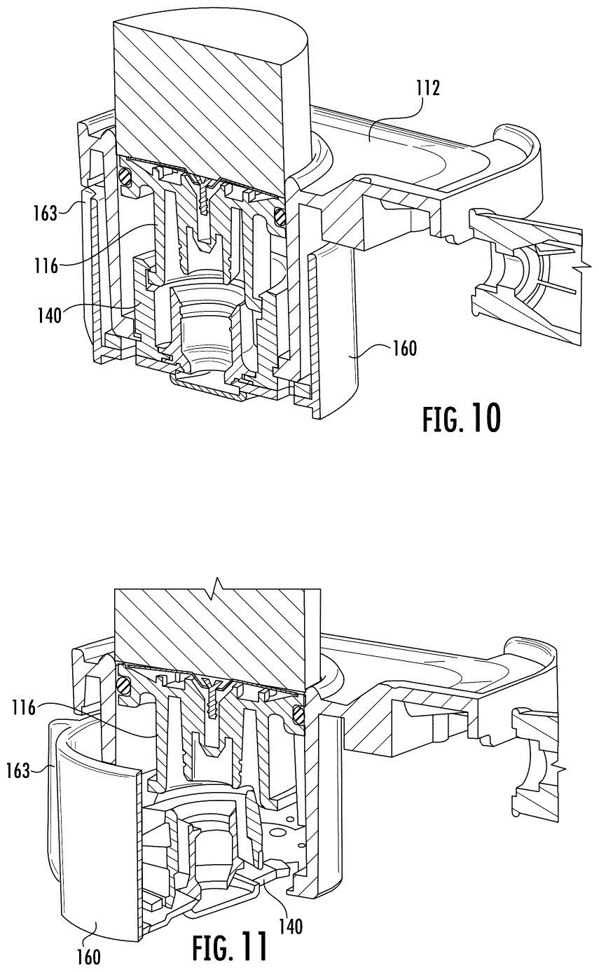

After brewing, the showerhead 184 rises to expose the puck (FIG. 7). The user then needs to remove the puck of grounds from the cavity 114 of the main basket 112. Rather than the user having to manually manipulate the puck from the cavity 114 (e.g., by digging it out with fingers, a spoon or knife, etc.) or “knocking” the portafilter 110 against a knockbox, the portafilter 110 of the present disclosure enables the user to dislodge the puck from the main basket 112. The user simply grasps the cover 160 (aided by gripping features 163 - visible in FIG. 9 and FIG. 10) and rotates the cover 160 relative to the main basket 112. (From a vantage point above the main basket 112, the user rotates the cover 160 counterclockwise). Because the cover 160 is fixed to the lifting ring 140 via the corresponding magnets 146, 168, the lifting ring 140 also rotates counterclockwise. The relative movement of the lifting ring 140 and the main basket 112 causes the outer recesses 154 to rotate relative to the fingers 156, which in turn causes the lifting ring 140 (and the cover 160) to rise (moves vertically) relative to the main basket 112 (see FIGS. 8-11).

As the lifting ring 140 rotates and rises, the filter holder 116 also rises (moves vertically) relative to the main basket 112. In addition, the rotation of the lifting ring 140 relative to the filter holder 116 causes the feet 126 of the outer ring 124 of the filter holder 120 to rise within the inner recesses 150 in the inner surface 148 of the main wall 144 of the lifting ring 140. As a result, the filter holder 116 rises (moves vertically) relative to the lifting ring 140 (see again FIGS. 8-11).

Based on the foregoing discussion, it can be seen that the ascension of (a) the cover 160 and lifting ring 140 relative to the main basket 112 and (b) the lifting ring 140 relative to the filter holder 116 cause the filter holder 116 to rise (move vertically) considerably relative to the main basket 112. This movement is sufficient to force the puck up and out of the main basket 112, where it can be retrieved and discarded by the user.

Notably, the use of the arrangement described herein can reduce the distance/height needed to expel the puck from the main basket 112. Also, the relatively shallow angles defined by the inner and outer recesses 150, 154 (e.g., 40-70 degrees) can provide a reasonable mechanical advantage to the user in forcing the puck from the main basket 112 (the user must overcome the friction generated between the seal ring 118 and the inner wall of the main basket 112). Further, inclusion of the magnets 146, 168 as the joining technique between the cover 160 and the lifting ring 140 can facilitate the separation of these components for cleaning.

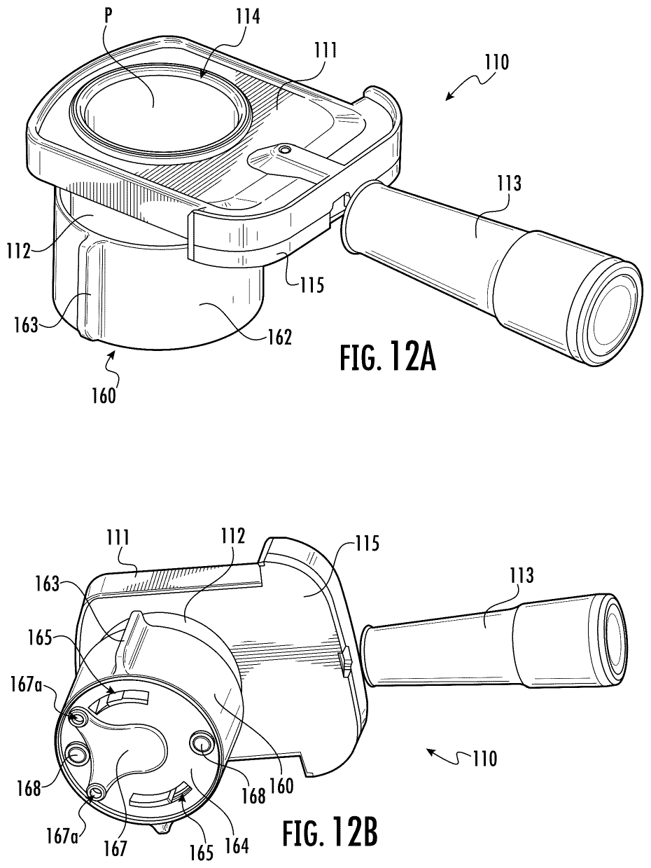

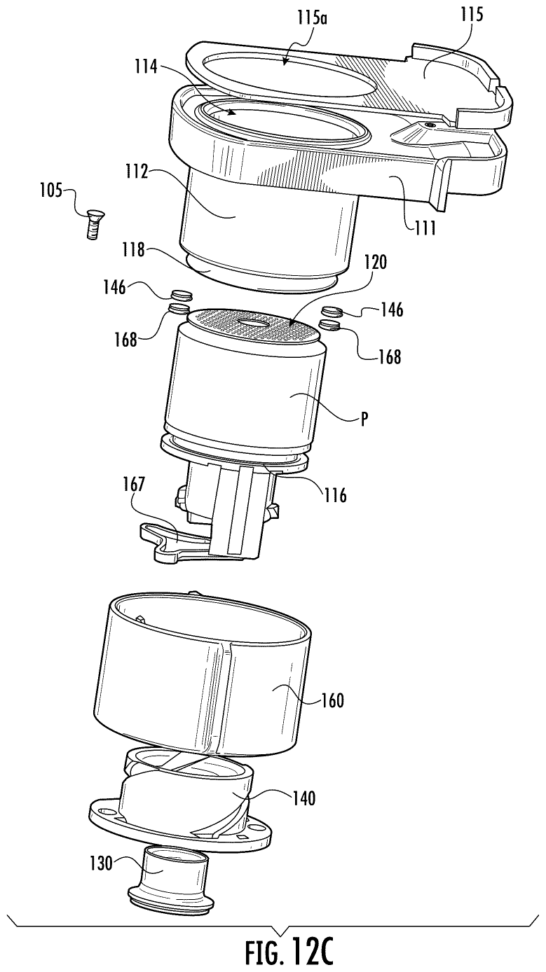

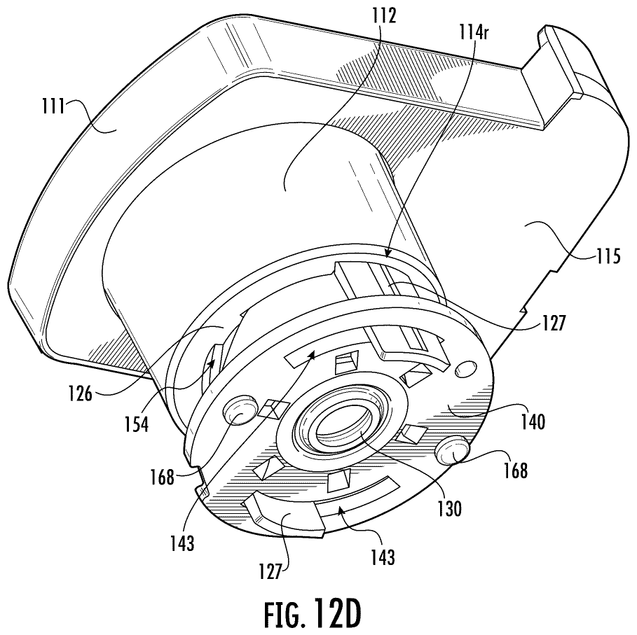

Referring now to FIGS. 12A-19B, the portafilter 110 of the present disclosure and components thereof (as described herein) are shown and described in further detail. FIGS. 12A-12D provide additional views of the portafilter 110 according to embodiments of the present disclosure. As described herein, and as shown in FIGS. 12A-12C, in some embodiments, the portafilter 110 comprises a main basket 112 having a cavity 114. In some embodiments, the portafilter 110 of the present disclosure may further comprise a filter plate 120, a filter holder 116, a diverting outlet 167, a lifting ring 140, and a boot 130. Each of these components are shown and described in further detail below.

As shown in FIGS. 12A-12B, the cavity 114 of the main basket 112 is configured to hold a “puck” P of coffee grounds. In some embodiments, the main basket 112 extends from a main chute 111. The main chute 111 is configured to be received by the housing 102 of the beverage maker, i.e., espresso machine 100 (see FIG. 1). In some embodiments, a bottom cover 115 may be coupled to or integral with the main chute 111. A handle 113 extends outwardly from the main chute 111 and provides a location for a user to grip the portafilter 110, for example, when inserting and removing the portafilter 110 from the espresso machine 100. A cover 160 having a wall 162 is positioned radially outwardly of the main basket 112. Magnets 168 may be embedded in a floor 164 of the cover 160 and positioned to align with corresponding magnets 146 embedded in the outer lip 142 of the lifting ring 140. Together the magnets 168, 146 are configured to keep the cover 160 engaged with (fixed to) the lifting ring 140 and the portafilter 110 as the cover 160 (and lifting ring 140) rotate and rise relative to the main basket 112. A diverting outlet 167 is fixed to the underside of the floor 164 and is configured to help direct the flow of brewed liquid (espresso) into one or two receptacles (e.g., cups) positioned on the stage 108 of the espresso machine 100 (see, e.g., FIG. 1).

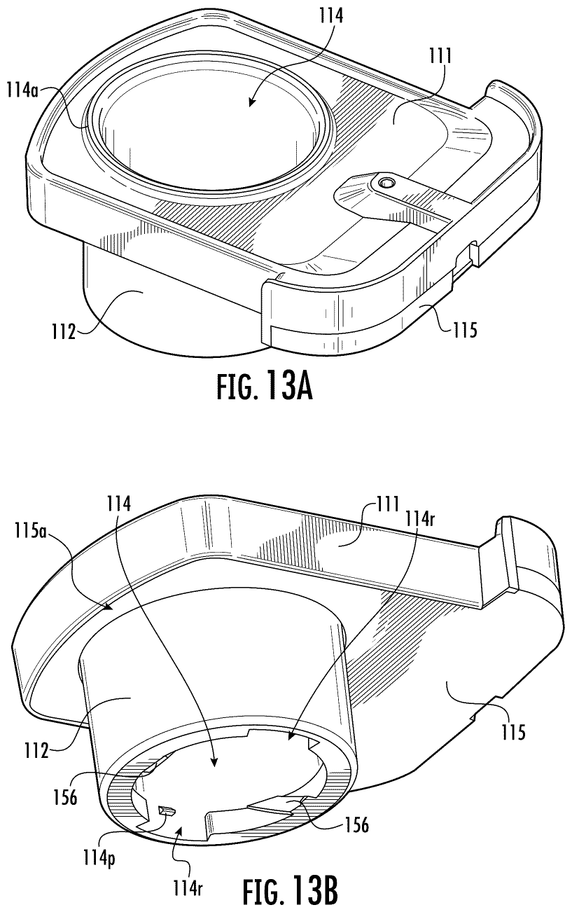

Referring to FIGS. 13A-13B, the main chute 111 and main basket 112 of the portafilter 110 is illustrated in greater detail. As shown in FIGS. 13A-13B, the main basket 112 extends downwardly from the main chute 111. In some embodiments, the main chute 111 comprises an annular lip 114a extending around an upper end (opening) of the cavity 114 of the main basket 112. In some embodiments, when the portafilter 110 is received by the housing 102 of the espresso machine 100 (FIG. 1), the annular lip 114a may help to provide a seal with the housing 102 (e.g., as heated water flows into the main basket 112 of the portafilter 110).

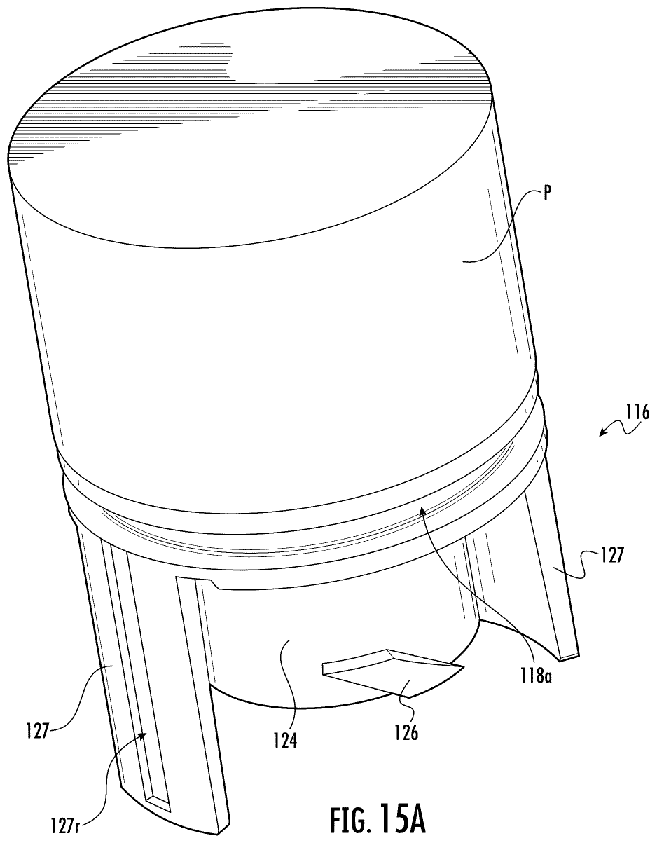

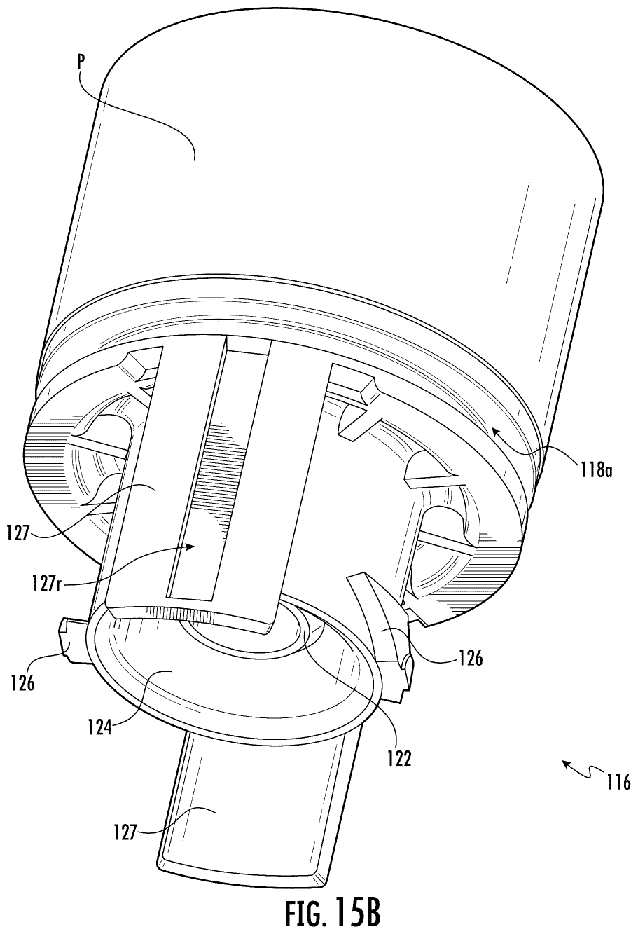

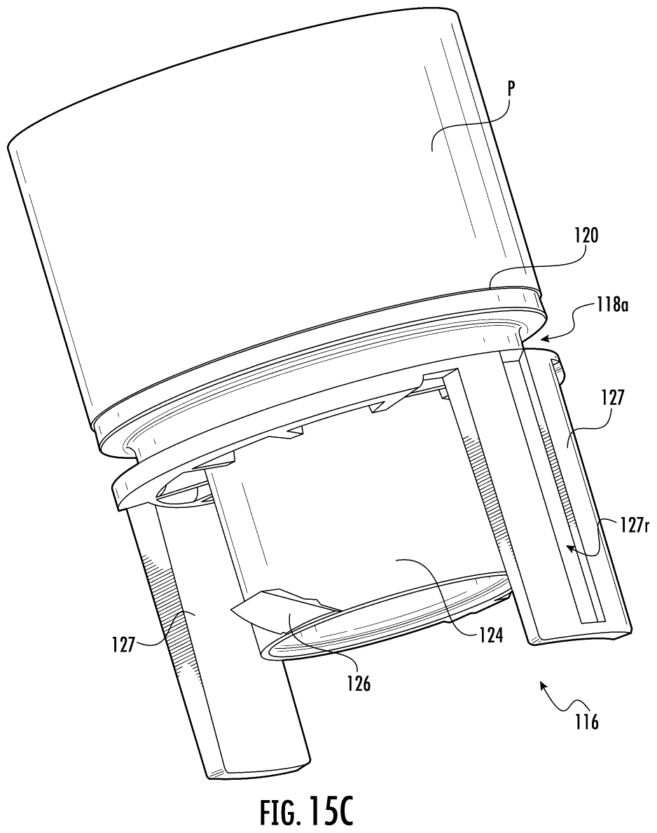

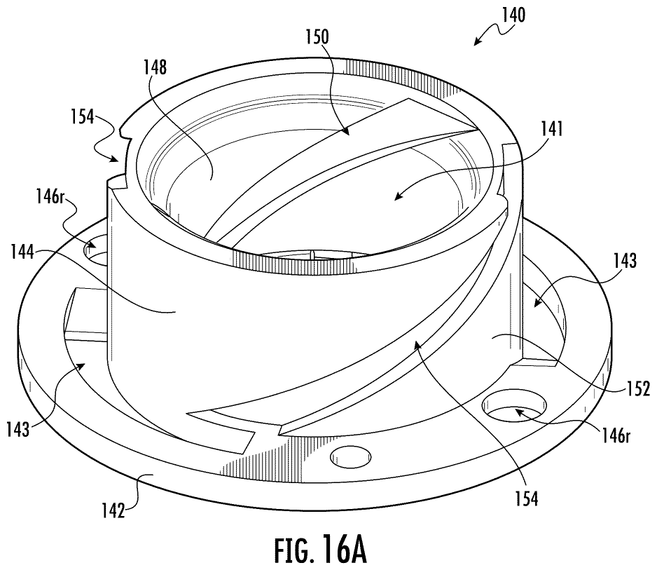

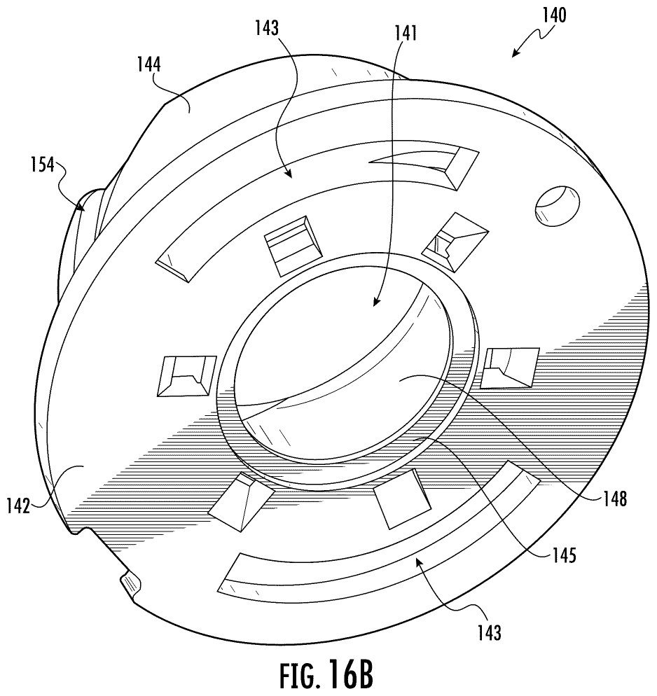

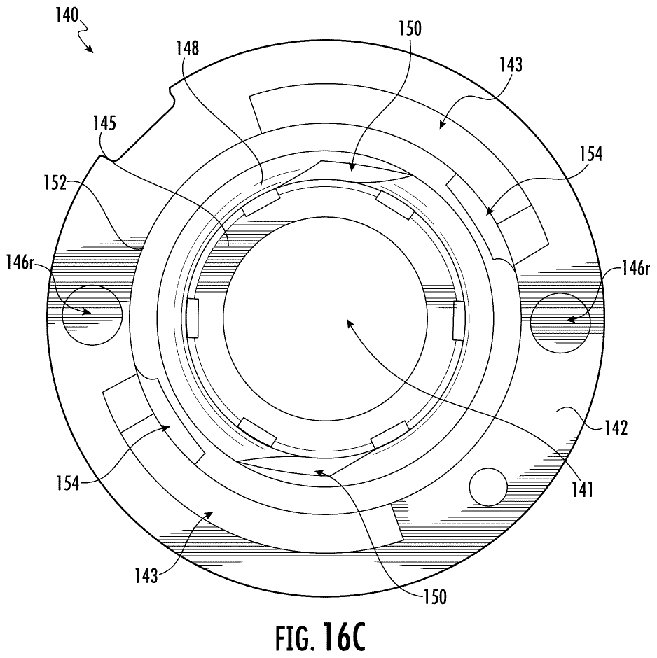

As shown in FIG. 13B, in some embodiments, the opposing lower end of the cavity 114 of the main basket 112 may comprises fingers 156. As described herein, each finger 156 is positioned and configured to be received in a respective outer recess 154 residing in the outer surface 152 of the main wall 144 of the lifting ring 140 (see also FIGS. 16A-16C). As further shown in FIG. 13B, in some embodiments, the lower end of the cavity 114 of the main basket 112 may also comprises two recesses 114r. Each recess 114r is configured to receive a corresponding arm member 127 of the filter holder 116 (see, e.g., FIG. 12D and FIGS. 15A-15C). In some embodiments, the inner surface of the cavity 114 of the main basket 112 may comprise one or more protrusions 114p. In some embodiments, each protrusions 114p may be configured to slide within a corresponding recess or channel 127r of a respective arm member 127 of the filter holder 116 to help guide the filter holder 116 as the filter holder 116 is being moved vertically (e.g., via the lifting ring 140) and/or to help keep the filter holder 116 coupled to the main basket 112.

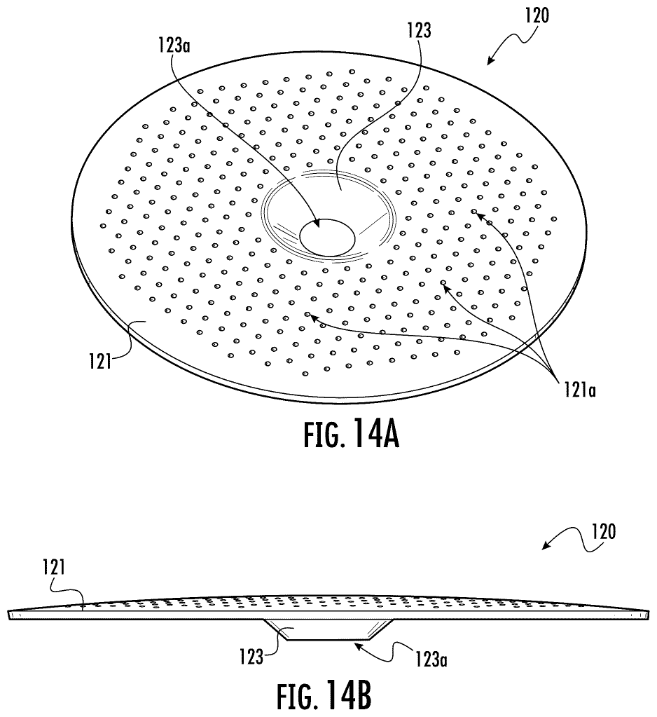

Referring to FIGS. 14A-14B, the filter plate 120 of the portafilter 110 is illustrated in greater detail. As described herein, filter plate 120 is mounted to the upper surface of the filter holder 116 (i.e., between the filter holder 116 and the puck P of ground coffee, see FIG. 15C). The filter plate 120 is porous having a plurality of apertures 121a which allow brewed liquid to descend through the filter plate 120. In some embodiments, a tapered section 123 with an aperture 123a may reside in a general center of the filter plate 120. The tapered section 123 and aperture 123a may provide a location to secure the filter plate 120 to the filter holder 116 via a fastener 105 (see, e.g., FIG. 3). As shown in FIG. 14B, in some embodiments, the outer surface 121 of the filter plate 120 may have a convex shape.

Referring to FIGS. 15A-15C, the filter holder 116 of the portafilter 110 is illustrated in greater detail. As described herein, the filter holder 116 is configured to be positioned within the cavity 114 of the main basket 112. As shown in FIGS. 15A-15C, in some embodiments, the filter holder 116 comprises an annular recess 118a. The annular recess 118a may be configured to receive at least a portion of the seal ring 118 that encircles the filter holder 116 and engages the inner wall of the main basket 112 (cavity 114) to provide a seal therebetween.

As further shown in FIGS. 15A-15C, the filter holder 116 comprises an inner ring 122 positioned below the filter plate 120 and an outer ring 124 surrounding the inner ring 124. A pair of feet 126 extends outwardly from the lower end of the outer ring 124 of the filter holder 116. As described herein, the inner ring 124 of the filter holder 116 is configured to fit within and engage the inner surface of the elastomeric boot 130, while the outer ring 124 is positioned radially outwardly from the elastomeric boot 130. Engagement of the inner ring 124 of the filter holder 116 and the elastomeric boot 130 may be further enhanced by one or more circumferential ridges 132 on an inner surface of elastomeric boot 130. Each foot 126 of the outer ring 124 of the filter holder 116 is configured to be received in a respective inner recess 150 in the inner surface 148 of the main wall 144 of the lifting ring 140. In addition, as described herein, the filter holder 116 also comprises a pair of arm members 127 positioned radially outwardly from the outer ring 124. In some embodiments, each arm member 127 may comprise a recess or channel 127r configured to receive a corresponding protrusion 114p extending from the inner surface of the cavity 114 of the main basket 112. In some embodiments, the arm members 127 of the filter holder 116 are configured to help guide the filter holder 116 as the filter holder 116 is being moved in a vertical direction relative to the main basket 112 and the lifting ring 140.

Referring to FIGS. 16A-16C, the lifting ring 140 of the portafilter 110 is illustrated in greater detail. In some embodiments, the lifting ring 140 is generally cylindrical and is positioned radially outwardly of the outer ring 124 of the filter holder 116. In some embodiments, an outer lip 142 extends radially outwardly from a lower end of a main wall 144 of the lifting ring 140. In some embodiments, the outer lip 142 comprises opposing slots 143. Each slot 143 is configured to receive a respective arm member 127 of the filter holder 116 (see FIG. 12D). Magnets 146 are embedded in the outer lip 142 (e.g., within recesses 146r in the outer lip 142). The main wall 144 of the lifting ring 140 defines a bore 141, The bore 141 is sized and configured to receive the inner ring 124 of the filter holder 116. In some embodiments, a bottom surface of the lifting ring 140 comprises an annular recess 145 (e.g., around a lower edge of the opening of the bore 141). In some embodiments, at least a portion of the elastomeric boot 130 may be configured to be received by the annular recess 145, thereby providing a seal.

As further shown in FIGS. 16A-16C, and as described herein, the inner surface 148 of the main wall 144 of the lifting ring 140 includes two partially-helical inner recesses 150. The feet 126 of the outer ring 124 of the filter holder 116 are configured to be received in the inner recesses 150. The outer surface 152 of the main wall 144 includes two partially-helical outer recesses 154. The fingers 156 of the main basket 112 extending from a lower lip 158 of the main basket 112 and are received in the outer recesses 154. As described herein, the relative movement of the lifting ring 140 and the main basket 112 causes the outer recesses 154 to rotate relative to the fingers 156, which in turn causes the lifting ring 140 (and the cover 160) to vertically move relative to the main basket 112 (see also FIGS. 8-11).

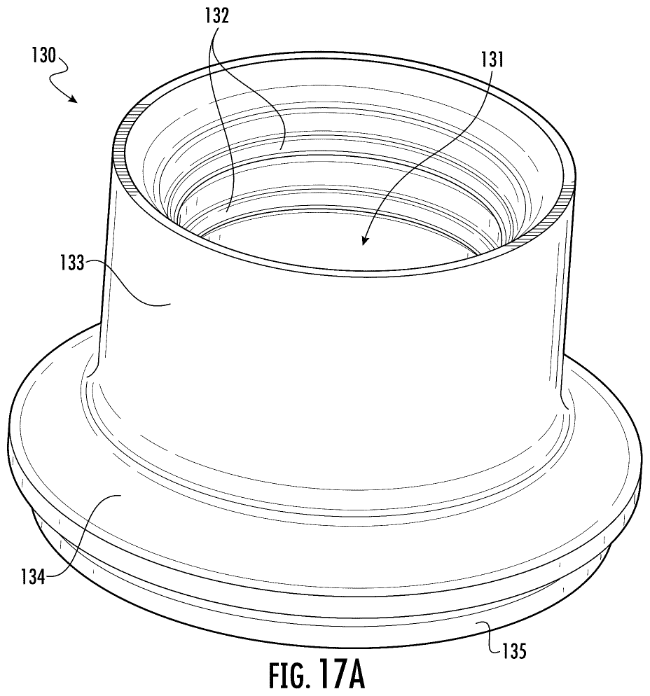

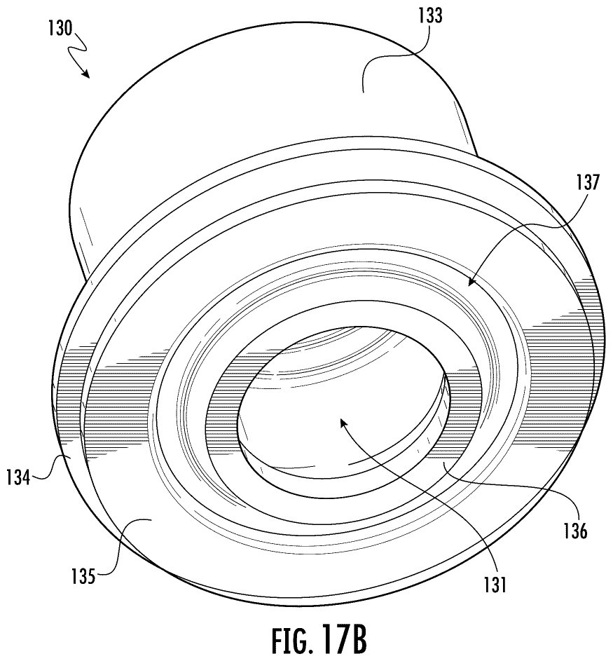

Referring to FIGS. 17A-17B, the elastomeric boot 130 of the portafilter 110 is illustrated in greater detail. In some embodiments, the elastomeric boot 130 has a generally cylindrical main wall 133 that defines a bore 131. The elastomeric boot 130 is positioned below the filter holder 116 and configured to engage therewith. For example, as described herein, the inner ring 124 of the filter holder 116 is configured to fit within and engage the inner surface of the main wall 133 of the boot 130 (i.e., fit within the bore 131 of the boot 130). Engagement between the filter holder 116 and the boot 130 may be enhanced by circumferential ridges 132 extending radially inwardly from the inner surface of the main wall 133 of the boot 130. The circumferential ridges 132 may also help to provide a tighter seal between boot 130 and the filter holder 116. An annular outer lip 134 extends radially outwardly from a lower end of the main wall 133 of the boot 130. In some embodiments, at least a portion of the annular outer lip 134 may be configured to be received by the annular recess 145 in the bottom surface of the lifting ring 140, thereby providing a seal therebetween.

As shown in FIG. 17B, in some embodiments, the boot 130 may comprise an annular inner lip 136 extending outwardly from the bottom surface 135 of the boot 130. The annular inner lip 136 may be configured to be received through the opening 166 in the floor 164 of the cover 160 to engage with the diverting outlet 167. As further shown in FIG. 17B, in some embodiments, the bottom surface 135 of the boot 130 may further comprise an annular recess 137 extending circumferentially around the annular lip 136 which may help to further create a seal between the elastomeric boot 130 and the cover 160.

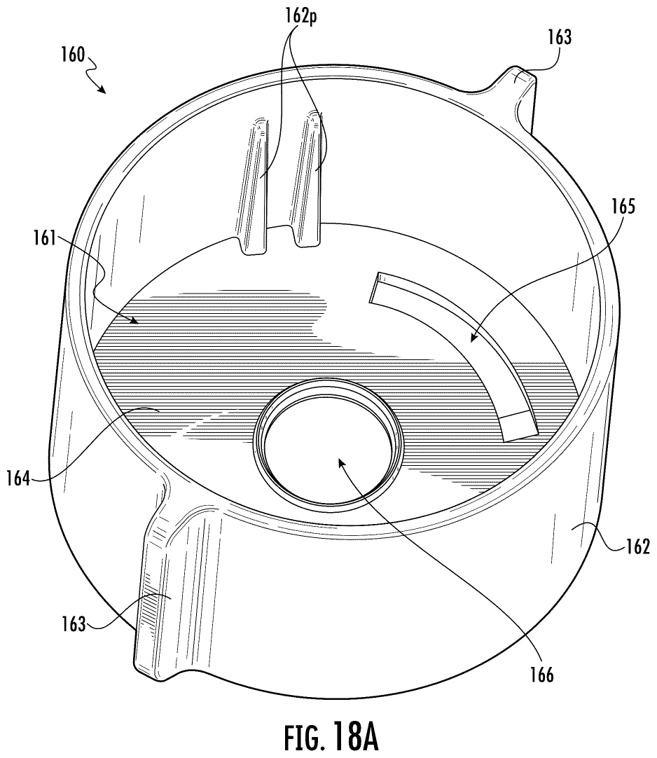

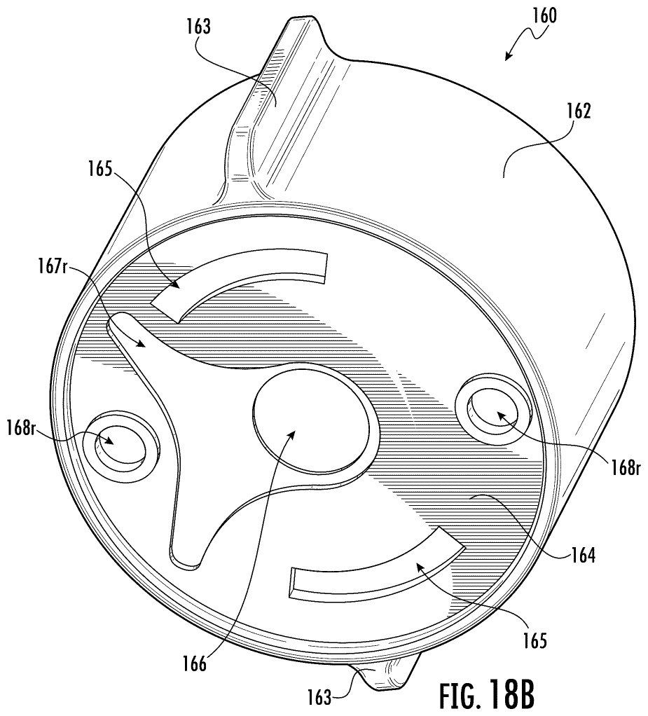

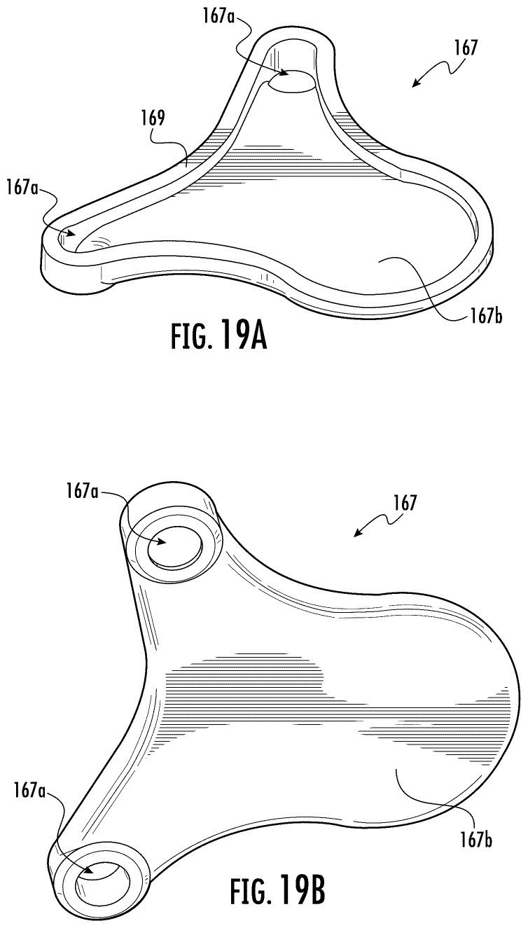

Referring now to FIGS. 18A-18B, the cover 160 of the portafilter 110 is illustrated in greater detail. As described herein, in some embodiments, the cover 160 is generally cylindrical having a wall 162 and a floor 164. The wall 162 is positioned radially outwardly of the main basket 112 and the floor 164 underlies the outer lip 142 of the lifting ring 140. An opening 166 in the floor 164 of the cover 160 permits brewed liquid to flow through the floor 164 and into the diverting outlet 167 that is fixed to the underside of the floor 164. In some embodiments, the underside of the floor 164 may comprise a recess 167r that matches the outer profile or shape of the diverting outlet 167. In some embodiments, the cover 160 also comprises opposing slots 165 in the floor 164. In some embodiments, the slots 165 may have an arcuate shape. In some embodiments, each slot 165 in the floor 164 may be configured to receive at least a portion of a respective arm member 127 of the filter holder 116 (see, e.g., FIG. 12B), thereby allowing the cover 160 to move (e.g., rotate) relative to the filter holder 116.

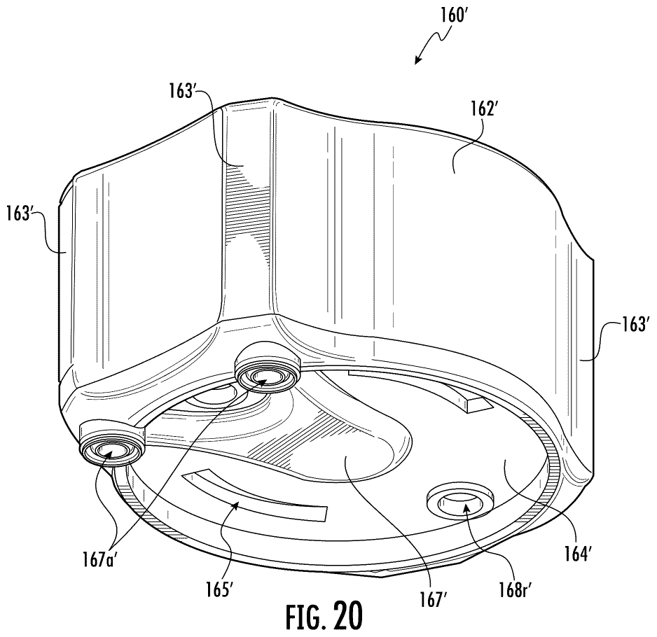

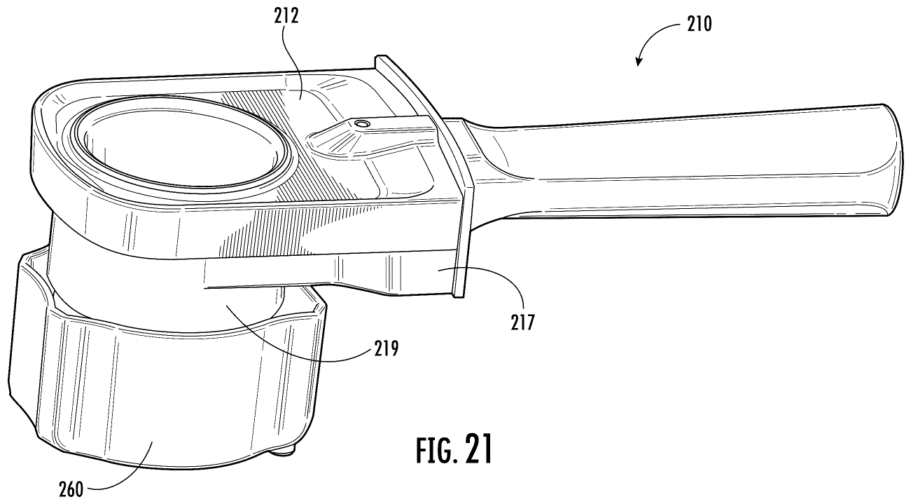

Magnets 168 are embedded in the floor 164 (e.g., within recesses 168r) at positions where the magnets 168 can align with the corresponding magnets 146 of the lifting ring 140, thereby enabling the cover 160 and the lifting ring 140 to rotate and lift together. One or more gripping features 163 may extend outwardly from the wall 162 of the cover 160. The gripping feature 163 may be a wing or similar protrusion that provide a location for a user to grasp the cover 160 (e.g., when rotating the cover 160 relative to the main basket 112) (see also FIG. 20). In some embodiments, an inner surface of the cover 160 may comprise one or more protrusions or rib members 162p.

Referring to FIGS. 19A-19B, the diverting outlet 167 of the portafilter 110 is illustrated in greater detail. As described herein, the diverting outlet 167 is fixed to the underside of the floor 164 of the cover 160. The diverting outlet 167 is configured to direct the flow of brewed liquid into two streams that are dispensed through two openings 167a into one or two receptacles positioned in the stage 108 (see FIG. 1). For example, as shown in FIGS. 19A-19B, in some embodiments, the diverting outlet 167 may have a sloped or tapered base 167b that helps direct the flow of brewed liquid toward the openings 167a. In some embodiments, an outer wall 169 extends upwardly from the base 167b. The outer wall 169 is configured to engage with the underside of the cover 160 (e.g., recess 167r) to form a seal between the diverting outlet 167 and the cover 160.

Referring to FIG. 20, an alternative cover 160′ and diverting outlet 167′ that may be used with the portafilter 110 are illustrated. The cover 160′ and diverting outlet 167′ are similar to the cover 160 and diverting outlet 167 described herein duplicate discussion thereof may be omitted herein for the purposes of discussing FIG. 20. As shown in FIG. 20, the cover 160′ is generally cylindrical having a wall 162′ and a floor 164′ . In some embodiments, the cover 160′ comprises opposing slots 165′ in the floor 164′ configured to receive at least a portion of a respective arm member 127 of the filter holder 116, thereby allowing the cover 160′ to move (e.g., rotate) relative to the filter holder 116. Magnets 168 are embedded in the floor 164′ (e.g., within recesses 168r′) at positions where the magnets 168 can align with the corresponding magnets 146 of the lifting ring 140, thereby enabling the cover 160′ and the lifting ring 140 to rotate and lift together. One or more gripping features 163 may extend outwardly from the wall 162′ of the cover 160′ . As shown in FIG. 20, the gripping features 163 may be a protrusion that provide a location for a user to grasp the cover 160′ (e.g., when rotating the cover 160′ relative to the main basket 112). As further shown in FIG. 20, the diverting outlet 167′ is fixed to the underside of the floor 164′ of the cover 160′ . The diverting outlet 167′ is configured to direct the flow of brewed liquid into two streams that are dispensed through two openings 167a′ into one or two receptacles positioned in the stage 108 (see FIG. 1). In some embodiments, the configuration of the cover 160′ allows for the openings 167a′ in the diverting outlet 167′ to be positioned in closer proximity to the one or two receptacles.

Referring now to FIGS. 21-27, another portafilter, designated broadly at 210, is shown therein. The portafilter 210 is similar to the portafilter 110 in that it relies on two helixes of opposite rotative directions to provide the lifting action to a puck of coffee grounds to help to remove the puck from the portafilter 210 but the features that provide the helical interactions are relocated on the components. The portafilter 210 is described in greater detail below.

Referring to FIGS. 21-27, the portafilter 210 includes a main basket 212, a filter holder 216, and a lifting ring 240. In addition, the portafilter 210 includes a basket support 217 to which the main basket 212 is mounted. The basket support 217 has a cylinder 219 that surrounds the cavity 214 of the main basket 212, and also includes an extension 221 that mounts to the handle of the portafilter 210.

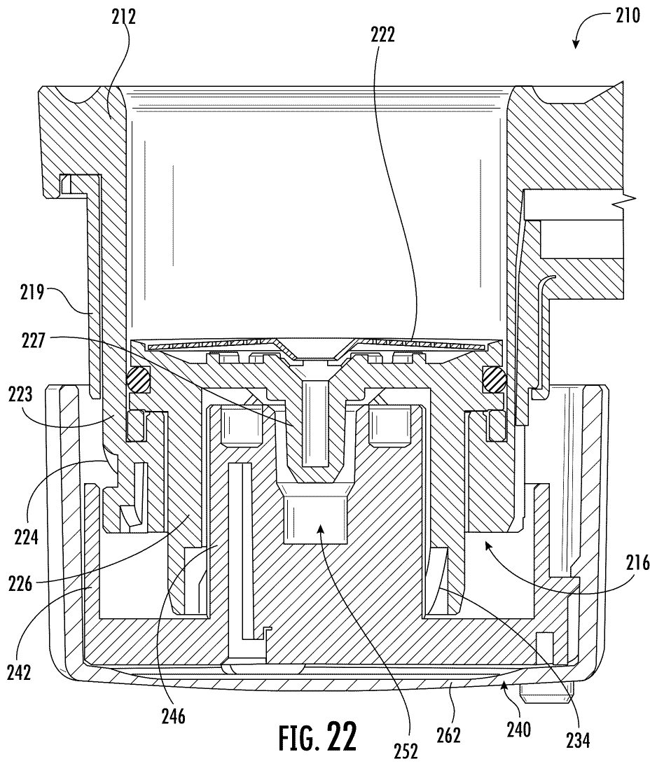

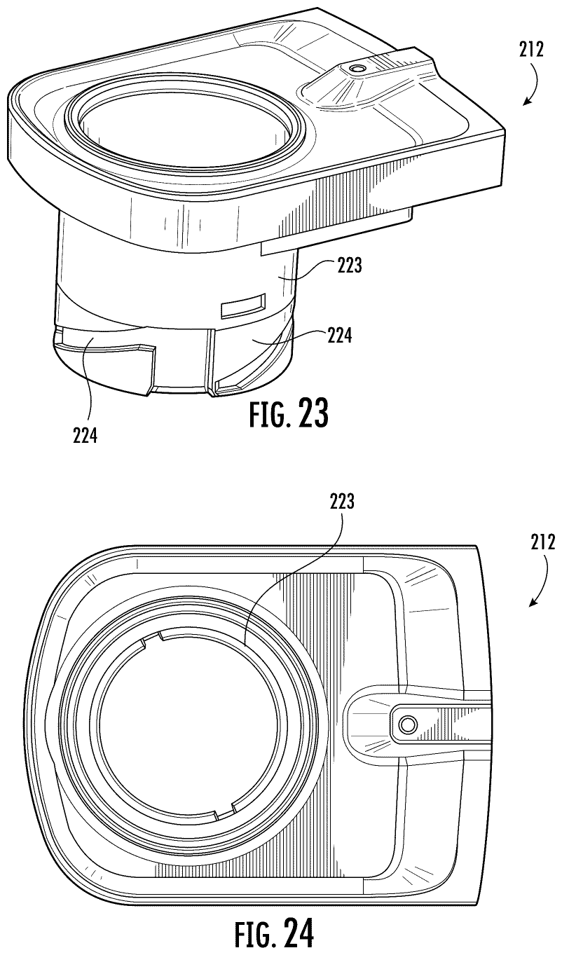

As shown FIG. 22, the side wall 223 of the main basket 212 extends below the lower edge of the cylinder 219 of the basket support 217. The side wall 223 has three partially helical recesses 224 (see also FIG. 23), each of which is positioned below the cylinder 219.

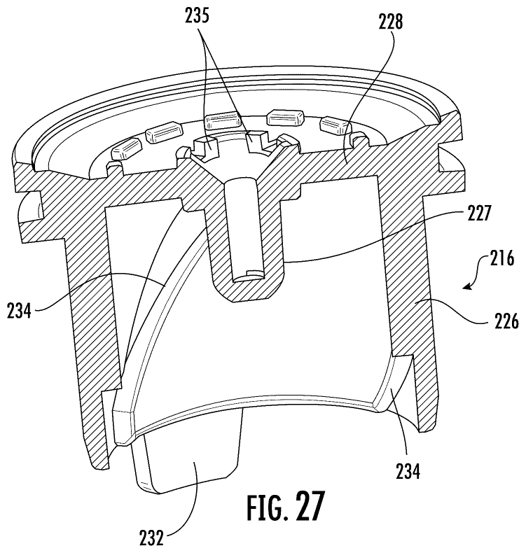

Referring now to FIGS. 26 and 27, the filter holder 216 has a generally cylindrical outer ring 226, an inner ring 227, and an upper plate 228 that supports a perforated filter 220 (FIG. 22). Two fingers 232 extend downwardly from the lower end of the outer ring 226. Two partially helical recesses 234 (FIG. 27) are located on the inner surface of the outer ring 226. Four holes 235 are present in the upper plate 228 adjacent the inner ring 227; these holes 235 provide a pathway for liquid through the upper plate 228.

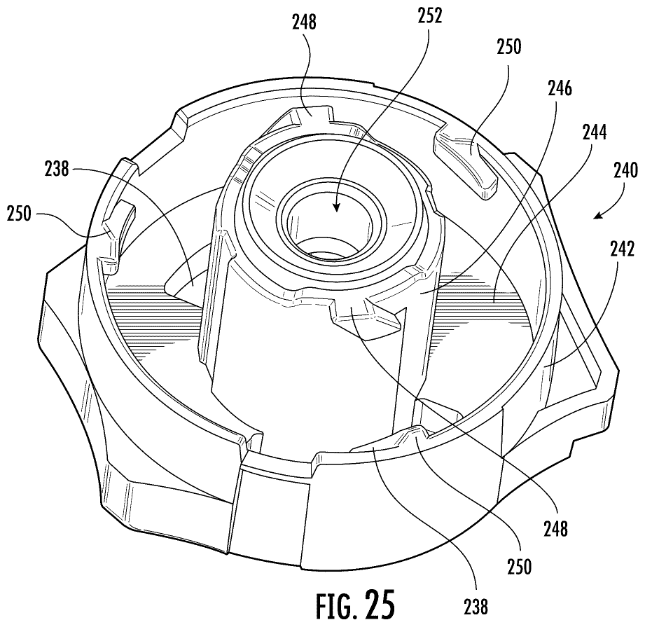

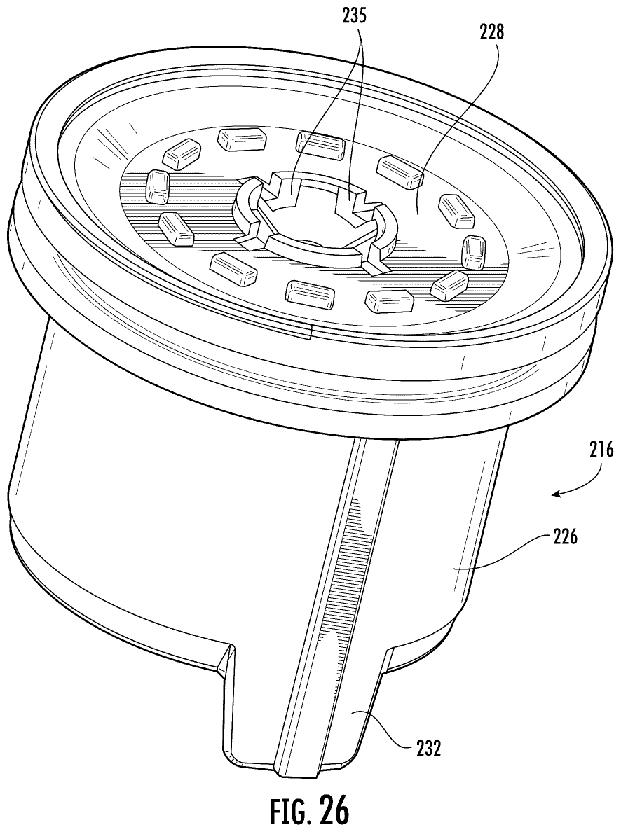

Referring now to FIG. 25, the lifting ring 240 includes an outer ring 242, a floor 244, and an inner tower 246. Two arced holes 238 are present in the floor 244 adjacent and on opposite sides of the tower 246. Above the holes 238, two angled nubs 248 extend radially outwardly from the upper end of the tower 246. Also, three nubs 250 extend radially inwardly from the upper edge of the inner surface of the outer ring 246. A bore 252 extends through the tower 246.

As can be seen from FIG. 22, when the portafilter 210 is assembled, the outer ring 242 of the lifting ring 240 is positioned radially outwardly of the side wall 223 of the main basket 212. Each of the nubs 250 on the outer ring 242 (not visible in FIG. 22) is received in a respective recess 224 of the side wall 223 of the main basket 212. The filter holder 216 is positioned so that the inner ring 227 is located within the bore 252 of the tower 246, and the outer ring 226 is positioned radially outwardly of the tower 246. The fingers 252 (not visible in FIG. 22) extend through the holes 238 in the floor 244 of the lifting ring 240. Each of the nubs 248 (not visible in FIG. 22) is received in a respective recess 234 in the outer ring 226. Notably, each of the recesses 224 in the side wall 223 of the main basket 212 defines a partial helix that is in the opposite rotative direction from the helices defined by the recesses 224 in the outer ring 226 of the filter holder 216 (e.g., the recesses 234 may define a clockwise partial helix, whereas the recesses 234 may define a counterclockwise partial helix). A cover 260 (FG. 21) much like the cover 160′ above is mounted to the lifting ring 240 in much the manner shown above.

Operation of the portafilter 210 is similar to that of the portafilter 110. The portafilter 210 is in a lowered position (shown in FIGS. 21 and 22), in which coffee grounds are added to the space defined by the side wall 223 of the main basket 212 and the filter 220 and tamped into place as described above. Espresso is brewed, with the liquid flowing from the brewing space through the holes 235 around the inner ring 227 of the filter holder 216 and through the diverting outlet 262 in the cover 260. When brewing is complete, the user grasps the cover 260 and rotates it (counterclockwise from the vantage point of FIG. 24). Rotation of the cover 260 also rotates the lifting ring 240 counterclockwise. As the lifting ring 240 rotates, the interaction between the nubs 250 and the recesses 226 in the side wall 223 of the main basket 212 causes the lifting ring 240 to rise relative to the main basket 212.

In addition, as the lifting ring 240 rotates, interaction between the nubs 248 of the lifting ring 240 and the recesses 234 in the filter holder 216 cause the filter holder 216 to rise relative to the lifting ring 240. The filter holder 216 is prevent from rotating by the fingers 232 extending thought the holes 238 in the floor of the lifting ring 240. Thus, the filter holder 216 rises sufficiently to expel the puck of coffee grounds from the main basket 212.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this disclosure.

What is claimed is:

1. A portafilter for a beverage-making machine, comprising:
a main basket with a cavity;
a filter holder positioned at least partially in the main basket;
a lifting ring that engages the filter holder and the main basket;
wherein one of the lifting ring and the main basket has a first recess that defines a first partial helix and the other of the lifting ring has a first nub received in the first recess; and
wherein one of the lifting ring and the filter holder has a second recess that defines a second partial helix and the other of the lifting ring and the filter holder has a second nub received in the second recess
wherein the first partial helix and the second partial helix are of opposite rotative directions; and
wherein rotation of the lifting ring causes the lifting ring to change elevation relative to the main basket and further causes the filter holder to change elevation relative to the main basket.

2. The portafilter defined in claim 1, further comprising a cover is detachably fixed to the lifting ring.

3. The portafilter defined in claim 2, wherein the lifting ring comprises an outer lip extending radially outwardly from a lower end of a main wall, the outer lip having at least one magnet embedded therein, and wherein at least one magnet is embedded in the floor of the cover and positioned to align with the at least one magnet of the lifting ring.

4. The portafilter defined in claim 1, wherein the filter holder comprises an inner tower and an outer ring surrounding the inner tower.

5. The portafilter defined in claim 4, wherein the lifting ring comprises a main wall defining a bore sized and configured to receive the inner tower of the filter holder.

6. The portafilter defined in claim 2, further comprising a diverting outlet fixed to an underside of the cover, wherein the cover comprises an opening in the floor that permits a flow of a brewed liquid through the floor and into the diverting outlet, the diverting outlet configured to direct the flow of the brewed liquid into one or two receptacles.

7. The portafilter defined in claim 1, wherein the filter holder comprises opposing foot members.

8. The portafilter defined in claim 1, further comprising a filter plate mounted to an upper surface of the filter holder.

9. The portafilter defined in claim 1, wherein the first and second recesses are on the lifting ring.

10. A portafilter for a beverage-making machine, comprising:
a main basket with a cavity;
a filter holder positioned at least partially in the main basket;
a lifting ring that engages the filter holder and the main basket;
wherein one of the lifting ring and the main basket has a first recess that defines a first partial helix and the other of the lifting ring has a first nub received in the first recess; and
wherein one of the lifting ring and the filter holder has a second recess that defines a second partial helix and the other of the lifting ring and the filter holder has a second nub received in the second recess
wherein the first partial helix and the second partial helix are of opposite rotative directions; and
a cover detachably fixed to the lifting ring;
wherein, when viewed from an overhead vantage point, counterclockwise rotation of the cover causes the lifting ring and the cover to change elevation relative to the main basket, and further causes the filter holder to change elevation relative to the main basket.

11. The portafilter defined in claim 10, wherein the cover is detachably fixed to the lifting ring via magnets.

12. The portafilter defined in claim 11, wherein the lifting ring comprises an outer lip extending radially outwardly from a lower end of a main wall, the outer lip having at least one magnet embedded therein, and wherein at least one magnet is embedded in the floor of the cover and positioned to align with the at least one magnet of the lifting ring.

13. The portafilter defined in claim 10, wherein the filter holder comprises an inner tower and an outer ring surrounding the inner tower.

14. The portafilter defined in claim 13, wherein the lifting ring comprises a main wall defining a bore sized and configured to receive the inner tower of the filter holder.

15. The portafilter defined in claim 10, further comprising a diverting outlet fixed to an underside of the cover, wherein the cover comprises an opening in the floor that permits a flow of a brewed liquid through the floor and into the diverting outlet, the diverting outlet configured to direct the flow of the brewed liquid into one or two receptacles.

16. The portafilter defined in claim 10, wherein the filter holder comprises opposing foot members.

17. The portafilter defined in claim 10, further comprising a filter plate mounted to an upper surface of the filter holder.

18. The portafilter defined in claim 10, wherein the first and second recesses are on the lifting ring.

19. A portafilter for a beverage-making machine, comprising:
a main basket with a cavity;
a filter holder positioned at least partially in the main basket;
a lifting ring that engages the filter holder and the main basket;
wherein one of the lifting ring and the main basket has a first recess that defines a first partial helix and the other of the lifting ring has a first nub received in the first recess; and
wherein one of the lifting ring and the filter holder has a second recess that defines a second partial helix and the other of the lifting ring and the filter holder has a second nub received in the second recess
wherein the first partial helix and the second partial helix are of opposite rotative directions; and
a cover detachably fixed to the lifting ring;
wherein rotation of the cover and the lifting ring causes the lifting ring to rise relative to the main basket, and wherein rotation of the cover and the lifting ring causes the filter holder to rise relative to the lifting.
